(19) United States
(12) Patent Application Publication
(10) Pub. No.: US 2026/0320850 A1
(43) Pub. Date: Oct. 15, 2026

(54) CULTURAL ADAPTATION OF VIDEO USING GENERATIVE ARTIFICIAL INTELLIGENCE

(71) Applicant: Adobe Inc., San Jose, CA (US)

(72) Inventors: Divyanshu GOYAL, Sunnyvale, CA (US); Akhil EPPA, San Jose, CA (US)

(21) Appl. No.: 19/175,545

(22) Filed: Apr. 10, 2025

(51) Int. Cl. G06T 11/00; G06T 7/20; G06T 13/80; G06V 10/762; G06V 20/40

(52) U.S. Cl. CPC G06T 11/00; G06T 7/20; G06T 13/80; G06V 10/762; G06V 20/41; G06V 20/46; G06T 2207/10016; G06T 2207/30244

(57) ABSTRACT

Some aspects relate to technologies providing a framework for generating culturalized videos using generative models. In accordance with some aspects, a source video is received, key frames are determined from the source video, image descriptions of the key frames are generated, and a video description is generated based on the image descriptions. Cultural concepts are identified from the image description of a first key frame of the key frames. A culturalized image description and a culturalized video description are generated based on the image description of a first key frame of the key frames, the video description, the cultural concepts, a target region, and predefined cultural guidelines. A culturalized image is generated based on the culturalized image description. A culturalized video is generated based on the culturalized video description and the culturalized image as the initial seed frame of the culturalized video.

### BACKGROUND

Adapting content to various conditions involves taking input and converting that input to conform to those various conditions. One example of adapting content is to adapt video to comport with different cultures, adding various culturally significant elements to a video while retaining underlying content, style, or structure. Adapting video to a particular culture generates a video that is more familiar to and that is more likely to resonate with persons of that culture. This adaptation poses various challenges, including determining culturally significant elements that may or may not be present in the video, resolving ambiguity, and incorporating context in a video to generate a culturally adapted video. One particular challenge is the ability to determine whether culturally significant concepts are present in the inputs or the results and adapting those inputs or results according to those concepts.

### SUMMARY

Some aspects of the present technology relate to, among other things, cultural adaptation of video using generative artificial intelligence (AI). In some aspects, the technology includes systems and methods for adapting video content to various cultural regions by leveraging generative models, such as large language models (LLMs), and a hierarchy of cultural guidelines. In various embodiments, a source video is received and a target region is selected in order to culturalize the source video for the target region. Key frames from the source video are determined using computer vision techniques. Image descriptions of the key frames, which include approximations of camera angles of the key frames, are generated using a vision language model, and a video description is generated based on the image descriptions of the key frames. Cultural concepts are identified from the image description of the first key frame of the source video. A culturalized image description of the first key frame and a culturalized video description of the source video are generated based on the image description of the first key frame, the video description of the source video, and cultural concepts for a target region that correspond to the identified cultural concepts. The culturalized image description and the structure of the first key frame of the source video are used to generate a culturalized image. The culturalized video is then generated using a generative video model based on the culturalized video description and the culturalized image, which serves as an initial seed frame for generating the culturalized video. The culturalized video is displayed to the user, thereby providing a culturally relevant video for the target region while maintaining visual resemblance to the source video in terms of camera motion and placement of objects.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a block diagram illustrating an example subsystem for extracting key frames of a source video, in accordance with some implementations of the present disclosure;

FIG. 3 is a block diagram illustrating an example subsystem for generating image descriptions, in accordance with some implementations of the present disclosure;

FIG. 4 is a block diagram illustrating an example subsystem for generating a video description, in accordance with some implementations of the present disclosure;

FIG. 5 is a block diagram illustrating an example subsystem for identifying cultural concepts, in accordance with some implementations of the present disclosure;

FIG. 6A is a block diagram illustrating a hierarchy of cultural guidelines, in accordance with some implementations of the present disclosure;

FIG. 6B is a block diagram illustrating an example of cultural guidelines, in accordance with some implementations of the present disclosure;

FIG. 7 is a block diagram illustrating an example subsystem for generating a culturalized image description and a culturalized video description, in accordance with some implementations of the present disclosure;

FIG. 8 is a block diagram illustrating an example subsystem for generating a culturalized image, in accordance with some implementations of the present disclosure;

FIG. 9 is a block diagram illustrating an example subsystem for generating a culturalized video, in accordance with some implementations of the present disclosure;

FIG. 10 is a flow diagram illustrating a method for generating a culturalized video, in accordance with some implementations of the present disclosure; and

FIG. 11 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, a “culturalized image” is an image that is altered to highlight cultural elements of a target culture (e.g., a region, country, or sub-culture of a region or country). A culturalized image is also referred to as a culturally translated image or a culturally adapted image.

As used herein, a “culturalized video” is a video that is altered to highlight cultural elements of a target culture (e.g., a region, country, or sub-culture of a region or country). A culturalized video is also referred to as a culturally translated video or a culturally adapted video.

As used herein, a “prompt” is an input to a generative model (e.g., an LLM or some other generative model) that causes the generative model to generate a response. In some instances, a prompt is generated by another generative model.

As used herein, a “source video” is an input video that is to be culturally adapted or culturalized. In some instances, a source video has existing cultural elements (e.g., from a first culture) that are to be replaced with cultural elements from a second culture. In some instances, a source video is culturally ambiguous.

As used herein, “key frames” are the important frames in a source video that are sufficiently different from other video frames of the source video. In some instances, key frames can be identified using any known computer vision technique.

As used herein, a “cultural guidelines hierarchy” is an organization of set of data that includes regions, cultural concepts, entities, and/or cultural guidelines. In some instances, a cultural guidelines hierarchy is organized by regions, with cultural concepts for each region, entities for each cultural concept, and cultural guidelines for each entity. In some instances, a cultural guidelines hierarchy is organized by cultural concepts, or by entities, or by cultural guidelines.

As used herein, a “region” is a cultural region (e.g., a country, populace, area within a country, area comprising multiple countries, and/or a subdivision of these). In some instances, a region comprises a cultural or country identity that has identifiable cultural concepts. In some instances, a country can have multiple regions.

As used herein, a “target region” is a desired region for culturalization. In some instances, for example, video culturalization is to adapt a source video to the cultural identity of a target region.

As used herein, a “cultural concept” is one of a broad category of cultural elements that can be used for cultural adaptation. Examples of cultural concepts include such things as birds, animals, plants, food, movies, urban elements, rural elements, cars, folklore, etc. In some instances, a cultural hierarchy includes a determined number of cultural concepts, with at least one entity for each of those cultural concepts, for each region.

As used herein, an “entity” is an instance of a culturally significant cultural concept for a region. In some cases, for a particular cultural concept and region, there are one or more entities of that cultural concepts that are culturally significant to that region. For example, for a particular region (e.g., Japan) and a particular cultural concept (e.g., Birds), there can be several entities that are culturally significant birds of Japan. In some cases, an entity is associated with multiple regions. In some instances, an entity is associated with a single cultural concept per region.

As used herein, a “cultural guideline” is a culturally significant aspect of an entity. In some instances, an entity has several cultural guidelines; for example, a crow, which is a bird found in Japan, can have several different cultural guidelines that indicate how a crow is viewed in Japan. In some instances, cultural guidelines for an entity in one culture are different than cultural guidelines for that same entity in another culture.

As used herein, an “image description” is a description of an image that is to be culturalized. As used herein, a “video description” is a description of a video that is to be culturalized. For instance, a video description captures the temporal context across frames by describing detected objects that move in and out of the frames and estimating the camera motion for the video.

As used herein, a “culturalized image description” is an image description that is altered according to cultural guidelines so that the culturalized description of the image can be used to generate a culturalized image. In some instances, a culturalized image description includes style and/or structure elements retained from the image description.

As used herein, a “culturalized video description” is a video description that is altered according to cultural guidelines so that the culturalized description of the video can be used to generate a culturalized video.

As used herein, a “style” of an image comprises the elements of an image beyond the specific visual elements. For example, an image style can be blurry, bright, dark, warm, cold, cartoonish, etc. In some instances, an image style is derived from the image. In some instances, an image style is included with an image (e.g., as data and/or metadata).

As used herein, a “structure” of an image comprises the arrangement of visual elements of an image in relationship to each other and/or within the image. In some instances, structure is derived from the image. In some instances, structure is included with an image (e.g., as data and/or metadata).

As used herein, “camera angles” refer to the specific positioning and orientation of the camera when capturing a scene that helps convey the spatial relationships and movements within the video. Examples of camera angles include panning left and zooming out, panning right and zooming out, panning left and zooming in, panning right and zooming in, drone shot and zooming out, and drone shot and zooming in, and/or any other types of camera angles.

### Overview

Generating culturalized videos is challenging for many reasons. First, it is often difficult to determine which aspects of a video can be culturally adapted (or culturalized). Second, it is often difficult to adapt video by, for example, determining a cultural equivalence between elements of different cultures. Typical approaches are time and resource intensive. One such conventional approach involves a human user manually identifying key ideas conveyed by the source video and then gathering information about these key ideas as they relate to a new cultural setting in order to devise a cultural translation (e.g., from elements of the source culture to elements of the target culture). The user must then search for existing images and video using relevant keywords related to the new cultural context or create new video for the new cultural context, and then manually create new video to substitute elements based on the cultural translation in order to generate a culturalized video. Because there is typically no set metric for such translation, results can be inconsistent. Also, because such translations are typically performed with considerable human interaction (e.g., to identify elements in the source or target culture), they are error-prone and often inconsistent (e.g., translating some elements while missing others). Additionally, such translations are typically very specific in that a translation from, for example, Japanese culture to Indian culture has no bearing on or relevance to a translation from a Japanese culture to Brazilian culture or a translation from Indian culture to Brazilian culture. Additionally, such methods typically do not scale well, failing to account for new elements or new cultures.

Aspects of the technology described herein address the problems of conventional video culturalization by providing a video culturalization system that efficient and effectively culturally adapts videos by leveraging generative models, such as LLMs, and a hierarchy of culturalized guidelines. In operation, a user selects a source video and a target region in order to culturally adapt the source video for the target region via a user interface component.

In various embodiments, in order to generate a culturalized video based on the source video, key frames from the source video are determined using computer vision techniques. For example, the key frames of the source video are determined by clustering video frames of the source video into groups of video frames based on pixel intensity histograms for each video frame and applying a computer vision technique to select a best frame from each of the groups of video frames as the key frame for the group of video frames.

In various embodiments, image descriptions of the key frames, which include approximations of camera angles of the key frames, are generated using a vision language model, and a video description is generated based on the image descriptions of the key frames. For example, a vision language model generates image descriptions of the key frames, including detected objects and camera angles. An LLM then generates the video description that captures the temporal context across the key frames based on the image descriptions. Cultural concepts are identified from an image description of the first key frame of the source video. For example, an LLM is prompted to identify cultural concepts from the image description of the first key frame of the key frames based on a predefined list of cultural concepts, such as cultural concepts in predefined cultural guidelines hierarchy.

A culturalized image description of the first key frame and a culturalized video description of the source video are generated based on the image description of the first key frame, video description of the source video, and cultural concepts for a target region that correspond to the identified cultural concepts. For example, an LLM is prompted to determine corresponding cultural concepts for the target region based on the identified cultural concepts in the first key frame and predefined cultural guidelines. Using the corresponding cultural concepts for the target region, the LLM generates a culturalized image description based on the image description of the first key frame and a culturalized video description based on the video description of the source video.

The culturalized image description and the structure of the first key frame of the source video are used to generate a culturalized image. For example, a multi-modal generative model, such as a text-to-image model, generates a culturalized image based on the culturalized image description and the structure of the first key frame in order to ensure that the culturalized image maintains visual resemblance to the first key frame of the source video. The culturalized video is then generated using a generative video model based on the culturalized video description and the culturalized image. In various embodiments, as the culturalized image serves as a seed frame for generating the culturalized video and the culturalized video description includes a similar camera motion and placement of objects as the video description of the source video, the generated culturalized video maintains visual resemblance to the source video. The culturalized video is then displayed to the user via the user interface component.

Aspects of the technology described herein provide a number of improvements over existing technologies. For example, the steps of the aforementioned process to generate culturally adapted versions of a source video can be performed automatically and with no human intervention. A user can select a source video and a target region, and the steps of determining key frames of the source video, generating image descriptions of the key frames, generating a video description, identifying cultural concepts, generating a culturalized image description, generating a culturalized video description, generating a culturalized image, and generating a culturalized video can be performed automatically, as described herein, with the output of one operation being used as the input of a subsequent operation. The technology described herein results in less manual operations that are required to manually create a new video as a culturalized video, which results in a more efficient use of computing and network resources due to the decrease in the number of input/output operations and data communicated over a computer network (e.g., resulting in higher throughput, reduced latency and less packet generation costs as fewer packets are sent over a network).

Additionally, using the various generative models described herein enables a more consistent cultural adaptation of videos so that, for example, a single video can be culturally adapted to a number of cultures with consistent results. The various steps of determining key frames of the source video, generating image descriptions of the key frames, generating a video description, identifying cultural concepts, generating a culturalized image description, generating a culturalized video description, and generating a culturalized image to generate a culturalized video, results in an optimized, consistent output from the generative models used to generate the culturalized video. Another advantage of the technology described herein is that the generative models being applied automatically enables better results, since, for example, a single source video can have many video frames and the best of those can be chosen to generate a culturalized video that more closely resembles the source video.

### Example Systems for Generating a Culturalized Video

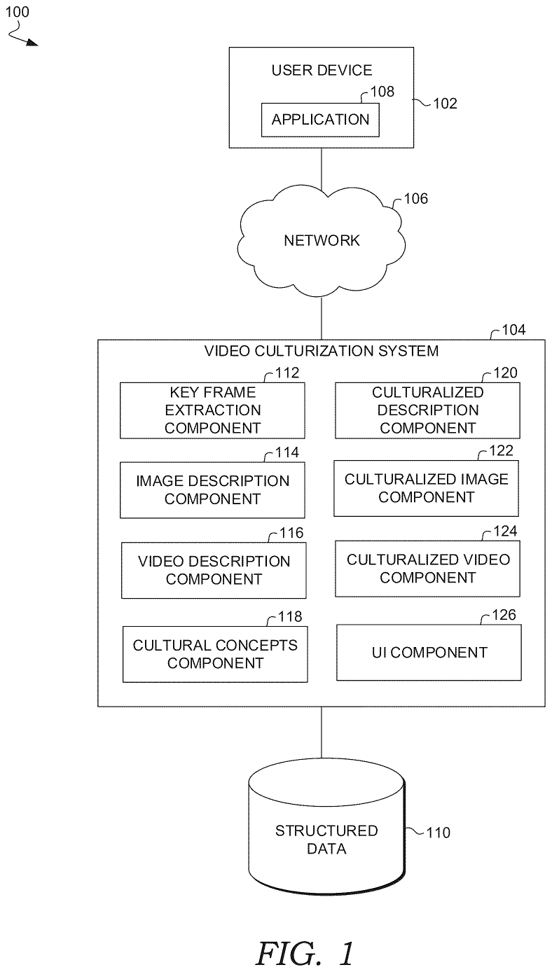

With reference now to the drawings, FIG. 1 is a block diagram illustrating an exemplary system 100 for automated cultural adaptation of video using generative AI in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

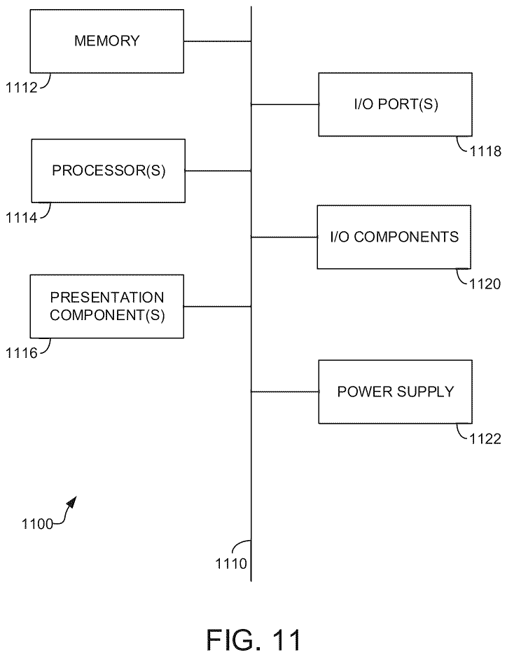

The system 100 is an example of a suitable architecture for implementing certain aspects of the present disclosure. Among other components not shown, the system 100 includes a user device 102 and a video culturalization system 104. Each of the user device 102 and the video culturalization system 104 shown in FIG. 1 can comprise one or more computer devices, such as the computing device 1100 of FIG. 11, discussed below. As shown in FIG. 1, the user device 102 and the video culturalization system 104 can communicate via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each may comprise a single device or multiple devices cooperating in a distributed environment. For instance, the video culturalization system 104 could be provided by multiple server devices collectively providing the functionality of the video culturalization system 104 as described herein. Additionally, other components not shown may also be included within the network environment.

The user device 102 can be a client device on the client-side of the system 100, while the video culturalization system 104 can be on the server-side of the system 100. The video culturalization system 104 can comprise server-side software designed to work in conjunction with client-side software on the user device 102 so as to implement any combination of the features and functionalities discussed in the present disclosure. For instance, the user device 102 can include an application 108 for interacting with the video culturalization system 104. The application 108 can be, for instance, a web browser or a dedicated application for providing functions, such as those described herein. This division of the system 100 is provided to illustrate one example of a suitable environment, and there is no requirement for each implementation that any combination of the user device 102 and the video culturalization system 104 remain as separate entities. While the system 100 illustrates a configuration in a networked environment with a separate user device and video culturalization system, it should be understood that other configurations can be employed in which aspects of the various components are combined. For instance, in some aspects, aspects of the video culturalization system 104 can be implemented in part or in whole by the user device 102.

The user device 102 can comprise any type of computing device capable of use by a user. For example, in one aspect, the user device 102 may be the type of computing device 1100 described in relation to FIG. 11 herein. By way of example and not limitation, the user device 102 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user can be associated with the user device 102 and can interact with the video culturalization system 104 via the user device 102.

The video culturalization system 104 is implemented as part of a conversational AI assistant that generates responses to user queries through natural language interaction. In such instances, the video culturalization system 104 uses AI and machine learning algorithms to understand user queries, interpret context, and generate responses by accessing relevant information from various sources, including data from the structured data 110. In at least one embodiment, the video culturalization system 104 uses one or more generative models such as those described herein to understand user queries, interpret context, and generate culturalized videos using systems, methods, operations, and techniques such as those described herein.

As shown in FIG. 1, the video culturalization system 104 comprises a key frame extraction component 112, an image description component 114, a video description component 116, a cultural concepts component 118, a culturalized description component 120, a culturalized image component 122, a culturalized video component 124, and/or a user interface (UI) component 126. The components/modules of the video culturalization system 104 may be in addition to other components/modules that provide further additional functions beyond the features described herein. The video culturalization system 104 can be implemented using one or more server devices, one or more platforms with corresponding application programming interfaces, cloud infrastructure, and the like. While the video culturalization system 104 is shown separate from the user device 102 in the configuration of FIG. 1, it should be understood that in other configurations, some or all of the functions of the video culturalization system 104 can be provided on the user device 102. Additionally, in some configurations, one or more of the components/modules of the video culturalization system 104 shown in FIG. 1 can be provided by the user device 102 and/or another location not shown in FIG. 1. The components/modules can be provided by a single entity or multiple entities.

In some aspects, the functions performed by components/modules of the video culturalization system 104 are associated with one or more applications, services, or routines. In particular, such applications, services, or routines may operate on one or more user devices, servers, may be distributed across one or more user devices and servers, or be implemented in the cloud. Moreover, in some aspects, these components/modules of the video culturalization system 104 may be distributed across a network, including one or more servers and client devices, in the cloud, and/or may reside on a user device. Moreover, these components/modules, functions performed by these components/modules, or services carried out by these components/modules can be implemented at appropriate abstraction layer(s) such as the operating system layer, application layer, hardware layer, etc., of the computing system(s). Alternatively, or in addition, the functionality of these components/modules and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components/modules shown in example system 100, it is contemplated that in some aspects, functionality of these components/modules can be shared or distributed.

The key frame extraction component 112 determines key frames of a source video using any known computer vision technique. For example, key frame extraction component 112 determines corresponding to video frames that are sufficiently different from other video frames of the source video based on absolute differences in the L*, u*, v* color space. In certain embodiments, key frame extraction component 112 clusters video frames of a source video into groups of video frames, for example via K-means clustering, based on pixel intensity histograms for each video frame. Computer vision techniques are applied to select the best frame from each of the groups of video frames. In certain examples, brightness score filtering can be applied to filter pixels of video frames and/or video frames above a threshold brightness score.

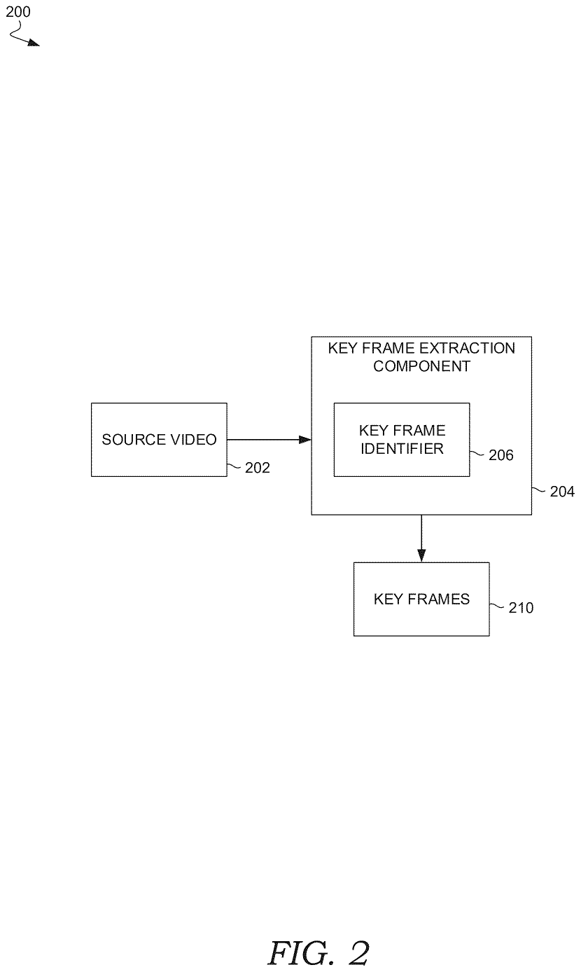

FIG. 2 is a block diagram 200 illustrating an example subsystem for determining key frames of a source video, in accordance with some implementations of the present disclosure. In some configurations, a source video 202 is received from a user device such as user device 102 by a key frame extraction component 204 (e.g., key frame extraction component 112). In some configurations, the source video 202 is provided to a key frame identifier, which performs one or more operations by applying computer vision techniques to determine key frames 210 of the source video 202.

With reference again to FIG. 1, image description component 114 generates an image description of the key frames. In certain embodiments, each image description includes detected objects in the key frame and camera angles of the key frames. Examples of camera angles includes: (1) panning left and zooming out, (2) panning right and zooming out, (3) panning left and zooming in, (4) panning right and zooming in, (5) drone shot and zooming out, (6) drone shot and zooming in, and/or any type of camera angle. In at least one embodiment, the image description component 114 uses a generative vision language model (e.g., a multimodal LLM, such as GPT-40) to generate the image description using systems, methods, techniques, and operations described herein. In some configurations, the image description component 114 receives, as input, the key frames, and generates a prompt to generate the image descriptions. The prompt is then provided to the generative model to generate the image description of each key frame (e.g., “‘image description’: ‘A delectable plate of biryani with vibrant saffron-colored rice, two perfectly halved boiled eggs, and succulent pieces of chicken garnished with cilantro. Silverware including a fork, knife, and spoon can be seen beside the plate, and a bowl of soup or curry is positioned nearby.’ ‘camera_movement’: ‘Panning Left and Zooming Out’”). In some configurations, the prompt to generate the image descriptions of the key frames include instructions to generate the image descriptions and estimate a corresponding camera angle for each key frame.

The generative model used by the image description component 114 to generate image descriptions for video culturalization can comprise a multi-modal language model that includes a set of statistical or probabilistic functions to perform Natural Language Processing (NLP) in order to understand, learn, and/or generate human natural language content based on input images. For example, a language model can be a tool that determines the probability of a given sequence of words occurring in a sentence or natural language sequence. Simply put, a language model can be a model that is trained to predict the next word in a sentence. A language model is called a large language model (LLM) when it is trained on an enormous amount of data and/or has a large number of parameters. Some examples of LLMs include those described above. These models have capabilities ranging from writing a simple essay to generating complex computer codes—all with limited to no supervision. In some configurations, a language model can receive image input (e.g., a source video) and provide a description of the image. Accordingly, an LLM can comprise a deep neural network that is very large (billions to hundreds of billions of parameters) and understands, processes, and produces human natural language by being trained on massive amounts of text. These models can predict future words in a sentence letting them generate sentences similar to how humans talk and write or otherwise communicate in a form dictated, for instance, by a prompt. In some aspects, the generative model used by the image description component 114 to generate image descriptions for video culturalization can be an off-the-shelf model or can be a custom model. In some aspects, the generative model used by the image description component 114 to generate image descriptions for video culturalization can comprise one or more of the models described herein and/or other such models.

In accordance with some aspects, the generative model used by the image description component 114 comprises a neural network. As used herein, a neural network comprises multiple operational layers, including an input layer and an output layer, as well as any number of hidden layers between the input layer and the output layer. Each layer comprises neurons. Different types of layers and networks connect neurons in different ways. Neurons have weights, an activation function that defines the output of the neuron given an input (including the weights), and an output. The weights are the adjustable parameters that cause a network to produce a correct output.

In some configurations, the generative model used by the image description component 114 is a pre-trained model (e.g., GPT-4) that has not been fine-tuned. In other configurations, the generative model is a model that is built and trained from scratch or a pre-trained model that has been fine-tuned. In such configurations, the generative model can be trained or fine-tuned using training data. During training, weights associated with each neuron can be updated. Originally, the generative model can comprise random weight values or pre-trained weight values that are adjusted during training. In one aspect, the generative model is trained using backpropagation. The backpropagation process comprises a forward pass, a loss function, a backward pass, and a weight update. This process is repeated using the training data. The goal is to update the weights of each neuron (or other model component) to cause the generative model to produce useful image descriptions given input images. Once trained, the weight associated with a given neuron can remain fixed. The other data passing between neurons can change in response to a given input. Retraining the network with additional training data can update one or more weights in one or more neurons.

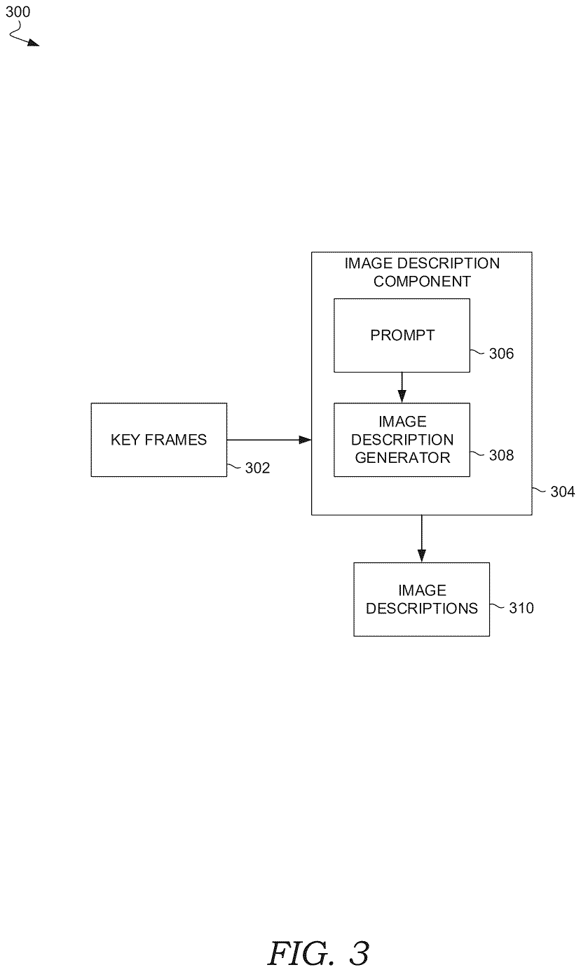

FIG. 3 is a block diagram 300 illustrating an example subsystem for generating image descriptions, in accordance with some implementations of the present disclosure. In some configurations, key frames 302 are received from a user device such as user device 102 by an image description component 304 (e.g., image description component 114). In some configurations, the image description component 304 generates, receives, or otherwise is provided with a prompt 306 to generate image descriptions 310 of key frames 302, as described above. In some configurations, the prompt 306 is provided to an image description generator 308, which performs one or more operations to generate image descriptions 310 of key frames 302. In at least one embodiment, the image description generator 308 is a multi-modal language model such as a multi-modal LLM. In at least one embodiment, the image description generator 308 is an off-the-shelf LLM such as GPT-40.

With reference again to FIG. 1, video description component 116 generates video description based on the image descriptions of the key frames. For example, the video description captures the temporal context across the key frames based on the detected objects and camera angles of the key frames as described in the image descriptions. In at least one embodiment, the video description component 116 uses a generative language model (e.g., an LLM, such as GPT-4) to generate the video description using systems, methods, techniques, and operations described herein. In some configurations, the video description component 116 receives, as input, the image descriptions of the key frames, and generates a prompt to generate the video description. The prompt is then provided to the generative model to generate the video description of the source video (e.g., “‘video description’: ‘A delightful spread of Indian dishes on a marble table, featuring a plate of biryani garnished with boiled eggs surrounded by bowls of curry, rice, naan, and roti, with neatly placed utensils enhancing the vibrant presentation.’, ‘camera_movement’: ‘Panning Left and Zooming Out’”). In some configurations, the prompt to generate the video description of the source video based on the key frames of the source video include instructions to estimate a camera motion of the source video based on estimated camera angles of each key frame in the image descriptions.

In some aspects, the generative model used by the video description component 116 to generate the video description can comprise a language model, can comprise a neural network, can be a pre-trained model (e.g., GPT-4) that has not been fine-tuned, or can be a fine-tuned model, all as described above in connection with the image description component 112. In some aspects, the generative model used by the video description component 116 to generate the video description can be an off-the-shelf model or can be a custom model. In some aspects, the generative model used by the video description component 116 to generate the video description can comprise one or more of these and/or other such models.

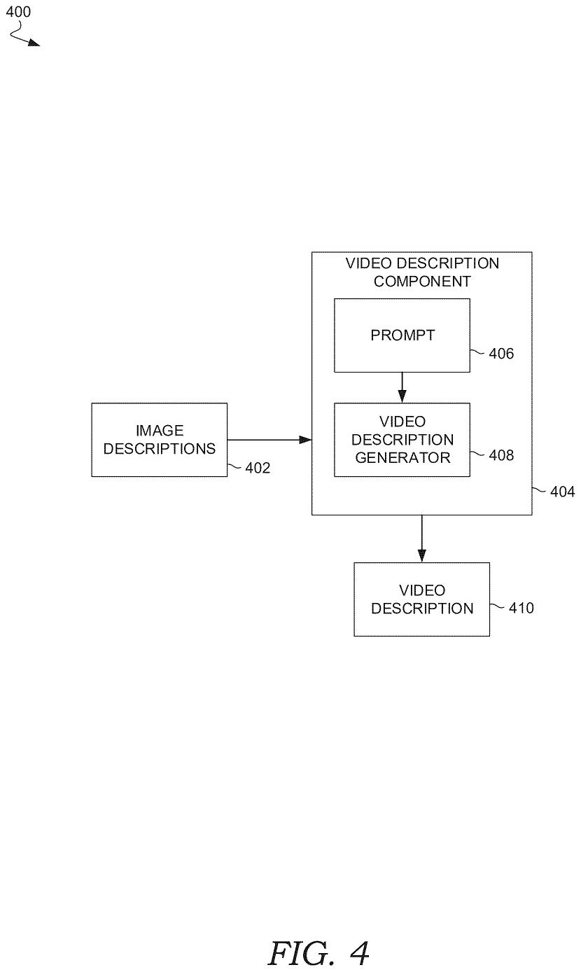

FIG. 4 is a block diagram 400 illustrating an example subsystem for generating a video description of a source video, in accordance with some implementations of the present disclosure. In some configurations, image descriptions 402 (e.g., image descriptions 310 of FIG. 3) are received from an image description component (e.g., an image description component 112 of FIG. 1) by video description component 404. In some configurations, video description component 404 generates, receives, or otherwise is provided with a prompt 406 to generate a description of a source video (e.g., source video 202 of FIG. 2), as described above. In some configurations, the prompt 406 is provided to a video description generator 408, which performs one or more operations to generate a video description 410. In at least one embodiment, the video description generator 408 is an off-the-shelf LLM, such as GPT-4.

With reference again to FIG. 1, the cultural concepts component 118 identifies cultural concepts of a key frame using the image description generated by the image description component 114. For example, the cultural concepts component 118 identifies cultural concepts from the image description of the first key frame of the key frames of the source video. In at least one embodiment, the cultural concepts component 118 uses a generative model (e.g., an LLM) to identify the cultural concepts using systems, methods, operations, and techniques described herein. In some aspects, the cultural concepts component 118 leverages a pre-defined list of cultural concepts to assist in identifying particular cultural concepts from the pre-defined list that are present in the image description. In some configurations, the cultural concepts component 118 receives, as input, the image description (e.g., of the first key frame of the key frames of the source video) and generates a prompt (e.g., “Given the list of cultural concepts and an image description, identify relevant concepts from the image description”) to identify the cultural concepts of the key frame. In some configurations, the cultural concepts component 118 receives, as input, the key frame. In some configurations, the cultural concepts component 118 does not receive the key frame as input. In some configurations, the cultural concepts component 118 returns a formatted list of concepts (e.g., {“Food”, “Beverages”, “Visual Arts”}) in response to the prompt.

In some aspects, the generative model used by the cultural concepts component 118 to identify the cultural concepts for image and/or video culturalization can comprise a language model, can comprise a neural network, can be a pre-trained model (e.g., GPT-4) that has not been fine-tuned, or can be a fine-tuned model, all as described above in connection with the image description component 112. In some aspects, the generative model used by the cultural concepts component 118 to identify cultural concepts for image and/or video culturalization can be an off-the-shelf model or can be a custom model. In some aspects, the generative model used by the cultural concepts component 118 to identify cultural concepts for image and/or video culturalization can comprise one or more of these and/or other such models.

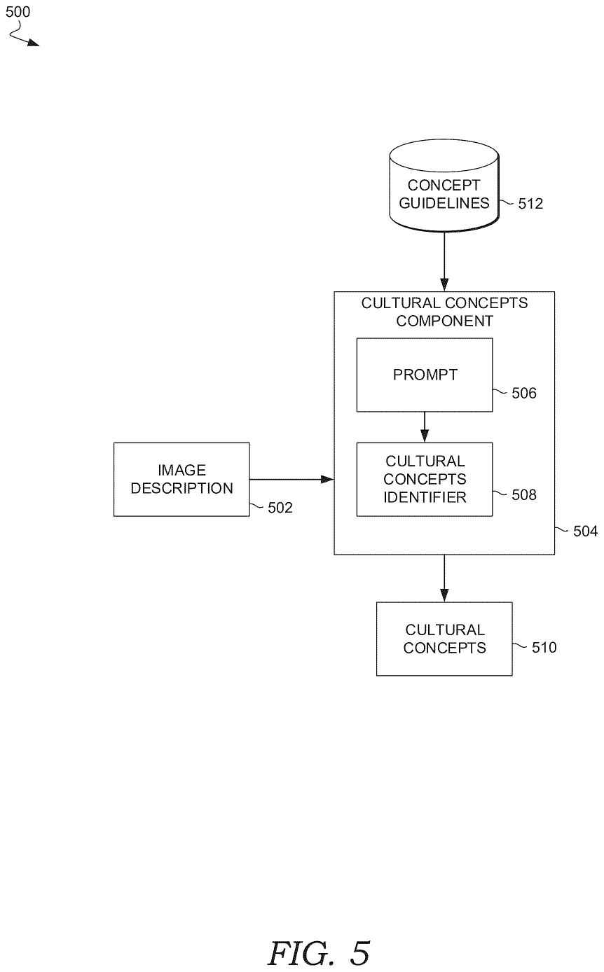

FIG. 5 is a block diagram 500 illustrating an example subsystem for identifying cultural concepts, in accordance with some implementations of the present disclosure. In some configurations, an image description 502 (e.g., image description 310) is received from an image description component (e.g., image description component 114) by a cultural concepts component 504 (e.g., cultural concepts component 118). In some configurations, the cultural concepts component 504 generates, receives, or otherwise is provided with a prompt 506 to identify cultural concepts from the image description 502, as described above. In some configurations, the prompt 506 is provided to a cultural concepts identifier 508, which performs one or more operations to identify cultural concepts 510. In some configurations, cultural concepts 510 comprises a plurality of cultural concepts from image description 502 (e.g., two, three, four, etc. cultural concepts). In at least one embodiment, cultural concepts identifier 508 is a language model such as an LLM. In at least one embodiment, cultural concepts identifier 508 is an off-the-shelf LLM such as GPT-4. In at least one embodiment, cultural concepts identifier 508 is a custom LLM, fine-tuned to identify cultural concepts from image description 502.

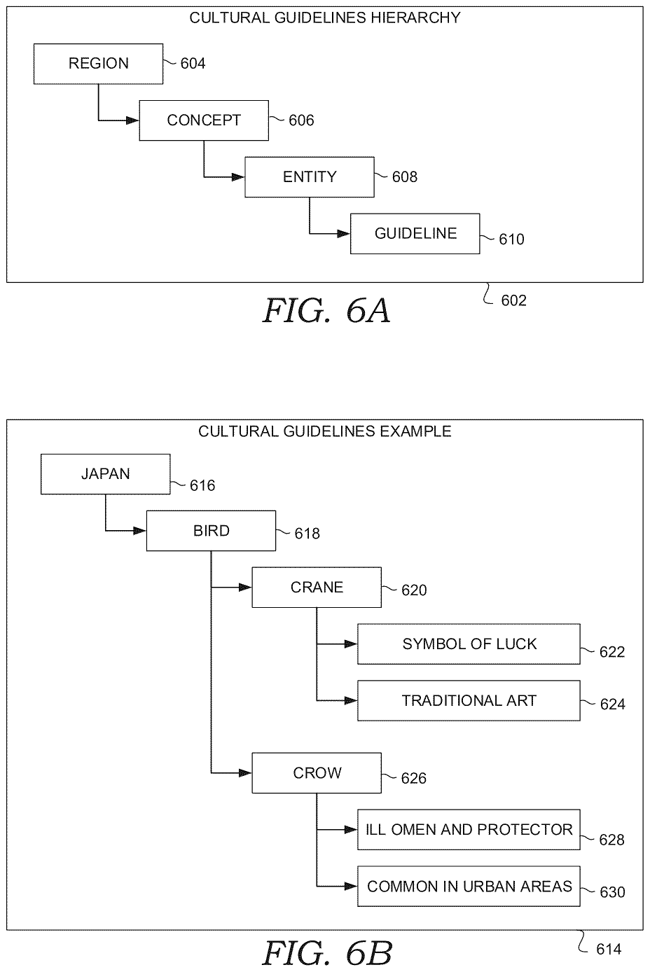

FIG. 6A is a block diagram illustrating a hierarchy of cultural guidelines, in accordance with some implementations of the present disclosure. A cultural guidelines hierarchy 602 includes, for each region 604, one or more cultural concepts 606, for each cultural concept 606, one or more entities 608, and for each entity 608, one or more cultural guidelines 610. In some configurations, cultural guidelines are used to inform cultural concepts (e.g., using a cultural concepts component 118) and are stored in a data store (e.g., structured data 110). For example, the cultural guidelines hierarchy 602 can be used by a language model to both identify culturally relevant entities (e.g., for a particular region and concept) and to provide cultural guidelines for utilizing those entities when culturalizing an image and/or video. It should be noted that the cultural guidelines hierarchy 602 shown in FIG. 6A is one example of many possible cultural guidelines hierarchies. For example, a cultural guidelines hierarchy could be organized with concepts at the top level, regions below that, and then entities and guidelines below that. In another example, a cultural guidelines hierarchy could be organized with concepts at the top level, entities at the next level, and guidelines organized by region so that each entity would have one or more regions with corresponding guidelines. In some configurations, cultural guidelines can be stored with no hierarchy so that they can be accessed using a lookup (e.g., “find guidelines for birds culturally relevant to Japan”).

FIG. 6B is a block diagram illustrating an example of cultural guidelines, in accordance with some implementations of the present disclosure. The cultural guidelines example 614 shown in FIG. 6B uses the cultural guidelines hierarchy 602 shown in FIG. 6A where, for each region 604, there are one or more cultural concepts 606, for each cultural concept 606, there are one or more entities 608, and for each entity 608, there are one or more guidelines 610. The cultural guidelines example 614 shown in FIG. 6B has a single region “Japan” 616, a single concept “Bird” 618, two entities “Crane” 620 and “Crow” 626, two cultural guidelines for “Crane” (“Symbol of Luck” 622 and “Traditional Art” 624), and two cultural guidelines for “Crow” (“Ill Omen and Protector” 628 and “Common in Urban Areas” 630). This cultural guidelines hierarchy enables a cultural concepts component 118 to identify cultural concepts in a key frame (e.g., that a crane is a bird of Japan that is a symbol of luck and is used in traditional art). This cultural guidelines hierarchy also enables a culturalized description component 120 to generate a culturalized image description and/or culturalized video description. For example, if a key frame includes a bird, and a target region for image and/or video culturalization is “Japan,” one or both of a crane or a crow can be used based on the cultural guidelines hierarchy (e.g., for an urban scene, a crow might be used in the culturalized image and/or video description).

With reference again to FIG. 1, the culturalized description component 120 generates (1) a culturalized image description of a key frame of the source video (e.g., the first key frame of the key frames of the source video) and (2) a culturalized video description of the source video using the cultural concepts identified by the cultural concepts component 118, concept guidelines (e.g., from structured data 110), an image description of the key frame (e.g., from image descriptions 310), a video description (e.g., video description 410) and a target region. In some instances, structured data 110 comprises a cultural guidelines hierarchy that sets forth a hierarchy of regions, cultural concepts, entities, and/or cultural guidelines. In at least one embodiment, culturalized description component 120 uses a generative model (e.g., an LLM) to generate a culturalized image description and a culturalized video description using systems, methods, operations, and techniques described herein. In some configurations, the culturalized description component 120 receives, as input, the cultural concepts, the predefined cultural guidelines hierarchy for the target region, the image description, the video description, and the target regions and generates a prompt to generate the culturalized image description and the culturalized video description. In some configurations, the culturalized description component 120 returns a culturalized image description (e.g., for Japan “A mouth-watering plate of sushi featuring a variety of nigiri, maki, and sashimi. The fresh, high-quality fish pieces are presented beautifully with accompaniments of soy sauce, wasabi, and pickled ginger. Chopsticks are placed elegantly beside the plate, and a small bowl of miso soup can be seen nearby.”). In some configurations, the culturalized description component 120 returns a culturalized video description (e.g., for Japan “A delightful spread of Japanese dishes on a tatami mat table, featuring a plate of assorted sushi garnished with fresh fish slices, surrounded by bowls of miso soup, rice, and pickles, with neatly placed chopsticks enhancing the elegant presentation. The camera pans left and zooms out to reveal the whole set-ting.”). In some embodiments, the instruction to generate the culturalized image description and the culturalized video description are included in a single prompt to the generative model (e.g., in order to ensure the contextually similarity of the culturalized image description and culturalized video description). In some configurations, the instructions to generate the culturalized video description include instructions to determine corresponding cultural concepts for the target region based on the cultural concepts and predefined cultural guidelines.

In some aspects, the generative model used by the culturalized description component 120 to generate a culturalized image description and a culturalized video description can comprise a language model, can comprise a neural network, can be a pre-trained model (e.g., GPT-4) that has not been fine-tuned, or can be a fine-tuned model, all as described above in connection with the image description component 114. In some aspects, the generative model used by the culturalized description component 120 to generate a culturalized image description and a culturalized video description can be an off-the-shelf model or can be a custom model. In some aspects, the generative model used by the culturalized description component 116 to generate a culturalized image description and a culturalized video description can comprise one or more of these and/or other such models.

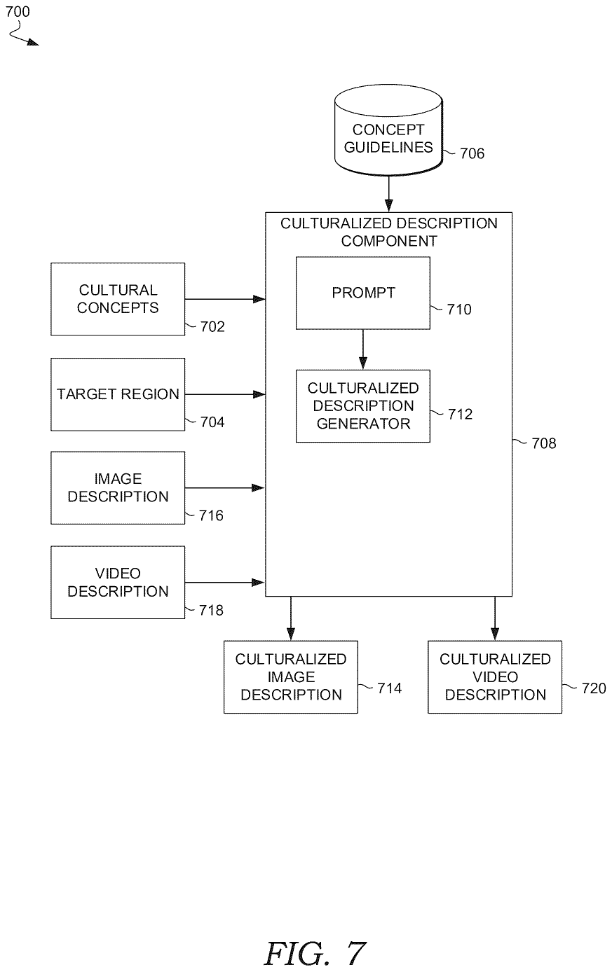

FIG. 7 is a block diagram 700 illustrating an example subsystem for generating culturalized descriptions, in accordance with some implementations of the present disclosure. In some configurations, cultural concepts 702 (e.g., cultural concepts 510) are received by a culturalized description component 708 (e.g., culturalized description component 120). In some configurations, an image description 716 (e.g., image description 310) is received by the culturalized description component 608. In some configurations, a video description 718 (e.g., video description 410) is received by the culturalized description component 708. In some configurations, a target region 704 is received from a user device such as user device 102 by the culturalized description component 708. In some configurations, cultural guidelines are retrieved from a cultural guidelines hierarchy in a concept guidelines 706 datastore (e.g., structured data 110) and are provided to the culturalized description component 708. In some configurations, the cultural guidelines are retrieved from the concept guidelines 706 datastore based on the cultural concepts 702 identified from the image description 716 for the target region 704. In some configurations, the culturalized description component 708 generates, receives, or otherwise is provided with a prompt 710 to generate a culturalized image description 714 and a culturalized video description 720 based, at least in part, on the image description 716, the video description 718, and the cultural concepts 702, using target regions 604 and cultural guidelines from the concept guidelines 706 datastore, as described above. In some configurations, the prompt 710 is provided to a culturalized descriptions generator 712, which performs one or more operations to generate a culturalized image description 714 and a culturalized video description 720 for a target region 704. In at least one embodiment, the culturalized descriptions generator 712 is a language model such as an LLM. In at least one embodiment, the culturalized descriptions generator 712 is an off-the-shelf LLM such as GPT-4.

With reference again to FIG. 1, culturalized image component 122 generates a culturalized version of the key frame, such as the first key frame of the key frames of the source video, using the culturalized image description generated by the culturalized description component 120. In at least one embodiment, culturalized image component 122 uses a multi-modal generative model, such as a text-to-image model, to generate a culturalized image using systems, methods, operations, and techniques described herein. In some configurations, the culturalized image component 122 receives, as input, the culturalized image description and generates a prompt (e.g., “Generate an image using this description.”) to generate the culturalized image. In some configurations, the culturalized image component 122 receives, as input, the key frame (e.g., the first key frame of the key frames of the source video). In some configurations, the culturalized image component 118 does not receive the key frame as input. In some configurations, the culturalized image component 122 receives one or more style or structure descriptions of the key frame, as described herein. In some configurations, image style and/or image structure comprise elements of an image that are in addition to the visual elements of the image. For example, image style can be blurry, bright, dark, warm, cold, cartoonish, etc. In another example, image structure is the arrangement of visual elements of an image in relationship to each other and/or within an image. In at least one embodiment, image style and/or image structure are obtained by analyzing an image (e.g., an input image) using computer vision techniques. For example, the text-to-image model may utilize computer vision techniques to analyze the image to obtain the structure of the image. The structure of the image can be used as context when the text-to-image model generates the culturalized image so that the culturalized image structurally resembles the key frame of the source video provided as input. In some configurations, the instructions to generate the culturalized image include instructions to generate the culturalized image based on the corresponding image description and structure of the corresponding key frame.

In some aspects, the culturalized image component 122 generates a prompt based on a natural language query received from the user device 102 (or at least a portion thereof) and provides the prompt to the generative model to generate a culturalized image. In some configurations, the prompt can include text instructing the generative model regarding how to generate the culturalized image. In some instances, the prompt is generated to include additional information to help guide the generative model in generating the culturalized image, as described above in connection with the image description component 114.

In some aspects, the generative model used by the culturalized image component 122 to generate a culturalized image can comprise a multi-modal language model, can comprise a neural network, can be a pre-trained generative model that has not been fine-tuned, or can be a fine-tuned model, all as described above in connection with the image description component 114. In some aspects, the generative model used by the culturalized image component 122 to generate a culturalized image can be an off-the-shelf model or can be a custom model. In some aspects, the generative model used by the culturalized image component 122 to generate a culturalized image can comprise one or more of these and/or other such models.

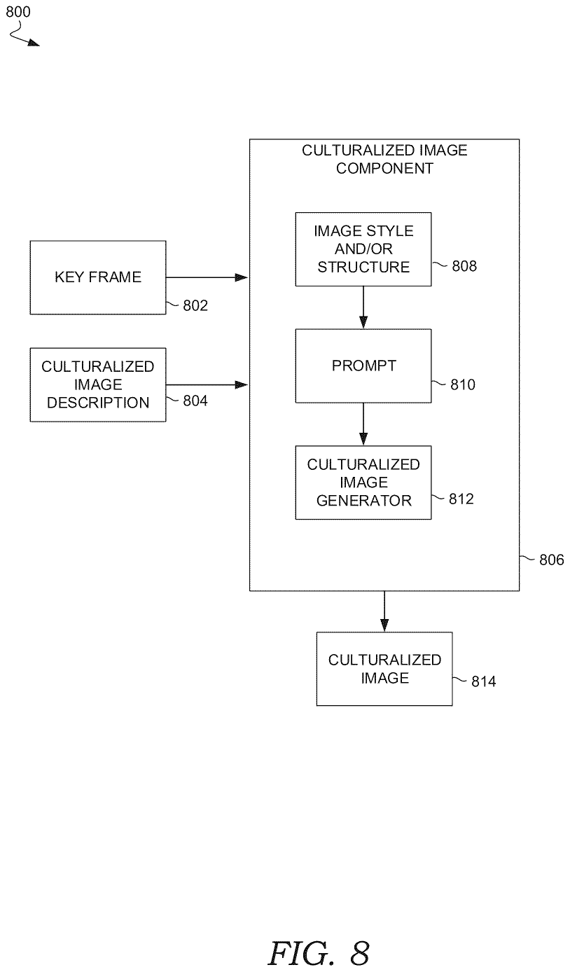

FIG. 8 is a block diagram 800 illustrating an example subsystem for generating a culturalized image, in accordance with some implementations of the present disclosure. In some configurations, a key frame 802 (e.g., the first key frame of the key frames of the source video 202) is received from a user device such as user device 102 by a culturalized image component 806 (e.g., culturalized image component 122). In some configurations, a culturalized image description 804 (e.g., culturalized image description 714) is received from a culturalized description component (e.g., culturalized description component 120) by the culturalized image component 806. In some configurations, the culturalized image component 806 generates, receives, or otherwise is provided with a prompt 810 to generate a culturalized image based, at least in part, on the culturalized image description 804. In some configurations, the prompt 810 is based, at least in part, on image style and/or structure 808, which is derived from key frame 802, by culturalized image component 806, such as by using any known computer vision technique. In some configurations, the prompt 810 is provided to a culturalized image generator 812, which performs one or more operations to generate a culturalized image 814. In at least one embodiment, the culturalized image generator 812 is a generative model (e.g., a generative AI model) that generates images from natural language inputs such as, for example, DALL-E 3, Midjourney, or various diffusion models.

With reference again to FIG. 1, culturalized video component 124 generates a culturalized version of the source video using the culturalized image generated by the culturalized image component 122 and culturalized video description generated by the culturalized description component 120. In at least one embodiment, culturalized video component 124 uses a multi-modal generative model, such as a generative video model, to generate a culturalized video using systems, methods, operations, and techniques described herein. In some configurations, the culturalized video component 124 receives, as input, the culturalized image and the culturalized video description and generates a prompt (e.g., “Generate a video using this description and the culturalized image as the initial seed frame of the video.”) to generate the culturalized video. In some configurations, the culturalized video component 124 receives, as input, the culturalized image as the initial seed frame of the video. In some configurations, the culturalized video component 124 does not receive the culturalized image as input. In some configurations, the instructions to generate the culturalized video include instructions to apply the culturalized image as an initial frame of the culturalized video.

In some aspects, the culturalized video component 124 generates a prompt based on a natural language query received from the user device 102 (or at least a portion thereof) and provides the prompt to the generative model to generate a culturalized video. In some configurations, the prompt can include text instructing the generative model regarding how to generate the culturalized video. In some instances, the prompt is generated to include additional information to help guide the generative model in generating the culturalized video, as described above in connection with the image description component 114.

In some aspects, the generative model used by the culturalized video component 124 to generate a culturalized video can comprise a multi-modal language model, can comprise a neural network, can be a pre-trained generative model that has not been fine-tuned, or can be a fine-tuned model, all as described above in connection with the image description component 114. In some aspects, the generative model used by the culturalized video component 124 to generate a culturalized video can be an off-the-shelf model or can be a custom model. In some aspects, the generative model used by the culturalized video component 124 to generate a culturalized video can comprise one or more of these and/or other such models.

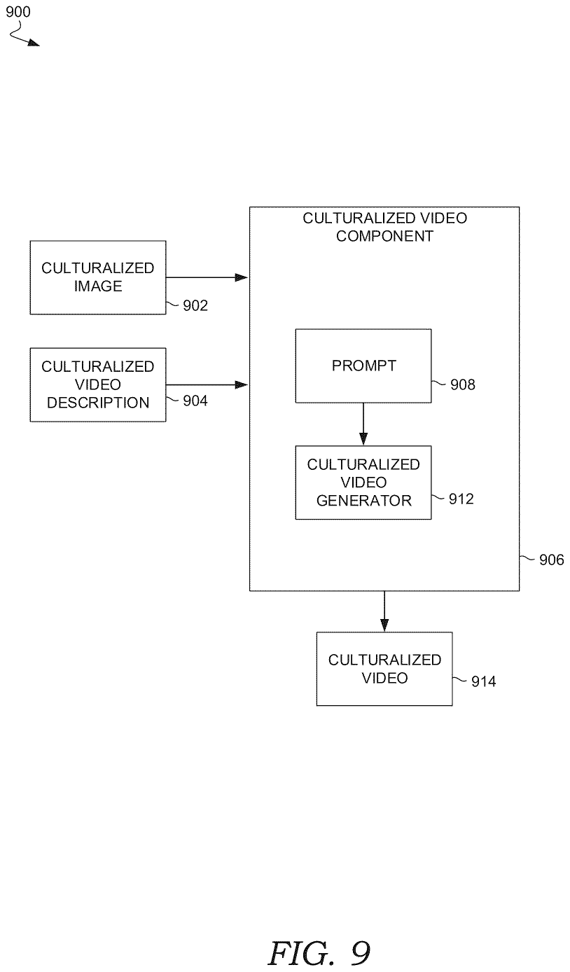

FIG. 9 is a block diagram 900 illustrating an example subsystem for generating a culturalized video, in accordance with some implementations of the present disclosure. In some configurations, a culturalized image 902 (e.g., culturalized image 814) is received from a user device such as user device 102 by a culturalized video component 906 (e.g., culturalized video component 124). In some configurations, a culturalized video description 904 (e.g., culturalized video description 720) is received from a culturalized description component (e.g., culturalized description component 120) by the culturalized video component 906. In some configurations, the culturalized video component 906 generates, receives, or otherwise is provided with a prompt 910 to generate a culturalized video based, at least in part, on the culturalized video description 904. In some configurations, the prompt 910 is based, at least in part, on instructions to generate the culturalized video based on the culturalized video description 904 and include instructions to apply the culturalized image 902 as an initial frame of the culturalized video 914. In some configurations, the prompt 910 is provided to a culturalized video generator 912, which performs one or more operations to generate a culturalized video 914. In at least one embodiment, the culturalized image generator 912 is a generative model (e.g., a generative AI model) that generates videos from natural language inputs (e.g., a text-to-video model) such as, for example, Adobe® Firefly, or various other generative video models.

Turning again to FIG. 1, the video culturalization system 104 further includes a user interface component 126 that provides one or more user interfaces for users to interact with the video culturalization system 104. For instance, the user interface component 126 provides one or more user interfaces to user devices, such as the user device 102. In some instances, the user interfaces can be presented on the user device 102 via the application 108, which can be a web browser or a dedicated application for interacting with the video culturalization system 104. Among other things, the user interface component 122 can provide user interfaces for interacting with the video culturalization system 104 to facilitate the generation of a culturalized video. For instance, the user interface component 122 can provide user interfaces enabling users to provide source video inputs and a selection of a target region. In some instances, the source video corresponds to a video clip of a scene corresponding to a single camera motion with respect to the scene. The user interface component 122 can also provide user interfaces to cause display of the culturalized video to the users.

### Example Methods for Generating a Culturalized Video

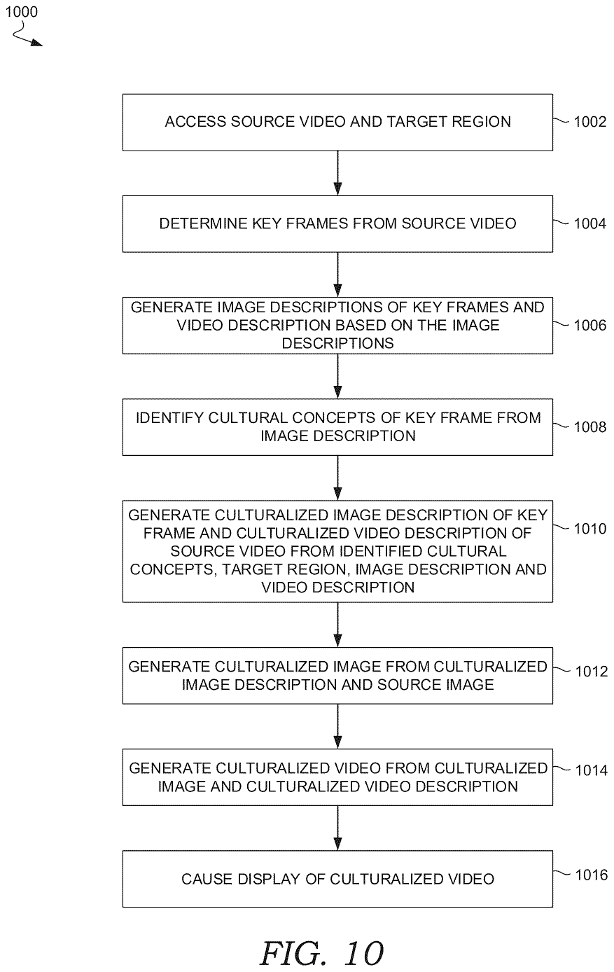

With reference now to FIG. 10, a flow diagram is provided that illustrates a method 500 for generating a culturalized video. The method 1000 can be performed, for instance, by video culturalization system 104 in FIG. 1. Each block of the method 1000 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

At block 1002, a source video and a target region are accessed. For example, a user selects a source video to be culturally adapted and selects the target region identifying the specific cultural region for which the adaptation is intended. The source video can be any video content that requires cultural adaptation, and the target region can be any geographical or cultural area that the video needs to be adapted for. In some embodiments, the source video corresponds to a video clip of a scene that only includes a single camera motion with respect to the scene.

At block 1004, the key frames of the source video are determined. For instance, key frames are determined that correspond to the important frames in the video that are sufficiently different from other frames and capture the essential elements of the video. In certain embodiments, computer vision techniques can be used to analyze the video and identify the key frames. In certain embodiments, the key frames of the source video are determined by clustering video frames of the source video into groups of video frames based on pixel intensity histograms for each video frame and applying a computer vision technique to select a corresponding key frame from each of the groups of video frames.

At block 1006, image descriptions of the key frames are generated and a video description is generated based on the image descriptions. For example, a vision language model generates image descriptions of the key frames, including detected objects and camera angles. An LLM generates the video description that captures the temporal context across the key frames based on the image descriptions of the key frames to provide a comprehensive description of the video content. In certain embodiments, the image descriptions of the key frames of the source video are generated based on applying a prompt to a vision language model with the key frames from the source video and instructions to generate the image descriptions and estimate a corresponding camera angle for each key frame. In certain embodiments, a language model is prompted to generate the video description based on the image descriptions of the key frames with instructions to estimate a camera motion of the source video based on estimated camera angles of each key frame in the image descriptions.

At block 1008, cultural concepts are identified from a key frame from the image description of the key frame. For example, an LLM is prompted to identify cultural concepts from the image description of the first key frame of the key frames. In certain embodiments, the cultural concepts are identified based on a predefined list of cultural concepts, such as cultural concepts in a predefined cultural guidelines hierarchy.

At block 1010, a culturalized image description of the key frame (e.g., the first key frame of the key frames) and a culturalized video description of the source video are generated based on the identified cultural concepts, target region, image description, and video description. For example, an LLM generates the culturalized image description and the culturalized video description. In certain embodiments, the prompt to the LLM to generate the culturalized image description and the culturalized video description includes instructions to determine corresponding cultural concepts for the target region based on the identified cultural concepts from the key frame and predefined cultural guidelines. In certain embodiments, the prompt to the LLM to generate the culturalized image description and the culturalized video description is a single prompt that includes instructions to generate both (1) the culturalized image description and (2) the culturalized video description in the same output.

At block 1012, a culturalized image is generated from the culturalized image description and the key frame. For example, a multi-modal generative model, such as a text-to-image model, generates a culturalized image based on the culturalized image description and the structure of the key frame. In certain embodiments, the culturalized image serves as an initial seed frame for generating the culturalized video and ensures that the cultural elements accurately resemble the location of the cultural elements in the source video. In certain embodiments, the prompt to the generative model to generate the culturalized image includes instructions to generate the culturalized image based on the corresponding image description and structure of the corresponding key frame.

At block 1014, a culturalized video is generated from the culturalized image and the culturalized video description. For example, a multi-modal generative model, such as a generative video model, generates a culturalized video based on the culturalized image and the culturalized video description. In certain embodiments, the prompt to the generative model to generate the culturalized video includes instructions to apply the culturalized image as an initial frame of the culturalized video.

At block 1016, the culturalized video is displayed. For example, a user interface component displays the culturalized video in order for a user to view the culturalized video on the user device.

### Exemplary Operating Environment

Having described implementations of the present disclosure, an exemplary operating environment in which embodiments of the present technology may be implemented is described below in order to provide a general context for various aspects of the present disclosure. Referring initially to FIG. 11 in particular, an exemplary operating environment for implementing embodiments of the present technology is shown and designated generally as computing device 1100. Computing device 1100 is but one example of a suitable computing environment and is not intended to suggest any limitation as to the scope of use or functionality of the technology. Neither should the computing device 1100 be interpreted as having any dependency or requirement relating to any one or combination of components illustrated.

The technology may be described in the general context of computer code or machine-useable instructions, including computer-executable instructions such as program modules, being executed by a computer or other machine, such as a personal data assistant or other hand-held device. Generally, program modules including routines, programs, objects, components, data structures, etc., refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 11, computing device 1100 includes bus 1110 that directly or indirectly couples the following devices: memory 1112, one or more processors 1114, one or more presentation components 1116, input/output (I/O) ports 1118, input/output components 1120, and illustrative power supply 1122. Bus 1110 represents what may be one or more busses (such as an address bus, data bus, or combination thereof). Although the various blocks of FIG. 11 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 11 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 11 and reference to “computing device.”

Computing device 1100 typically includes a variety of computer-readable media. Computer-readable media can be any available media that can be accessed by computing device 1100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1100. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1112 includes computer storage media in the form of volatile and/or nonvolatile memory. The memory may be removable, non-removable, or a combination thereof. Exemplary hardware devices include solid-state memory, hard drives, optical-disc drives, etc. Computing device 1100 includes one or more processors that read data from various entities such as memory 1112 or I/O components 1120. Presentation component(s) 1116 present data indications to a user or other device. Exemplary presentation components include a display device, speaker, printing component, vibrating component, etc.

I/O ports 1118 allow computing device 1100 to be logically coupled to other devices including I/O components 1120, some of which may be built in. Illustrative components include a microphone, joystick, game pad, satellite dish, scanner, printer, wireless device, etc. The I/O components 1120 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 1100. The computing device 1100 may be equipped with depth cameras, such as, stereoscopic camera systems, infrared camera systems, RGB camera systems, and combinations of these for gesture detection and recognition. Additionally, the computing device 1100 may be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, unless indicated otherwise, the term “or” includes the conjunctive, the disjunctive, and both (a or b thus includes either a or b, as well as a and b). Further, the term “and/or” includes the conjunctive, the disjunctive, and both (a and/or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology may generally refer to the technical solution environment and the schematics described herein, it is understood that the techniques described may be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
generating, via a video description component, a video description of a source video based on applying, to a language model, a first prompt comprising image descriptions of key frames from the source video;
identifying, via a cultural concepts component, cultural concepts from a corresponding image description of the image descriptions based on applying, to the language model, a second prompt comprising the corresponding image description;
generating, via a culturalized description component, a culturalized image description from the corresponding image description and a culturalized video description from the video description based on applying, to the language model, a third prompt comprising the corresponding image description, the video description, the cultural concepts, and a target region;
generating, via a culturalized video component, a culturalized video based on applying, to a generative video model, a prompt comprising a culturalized image from the culturalized image description and the culturalized video description; and
causing display, via a user interface component, of the culturalized video.

2. The one or more computer storage media of claim 1, the operations further comprising:
determining the key frames of the source video by clustering video frames of the source video into groups of video frames based on pixel intensity histograms for each video frame and applying a computer vision technique to select a corresponding key frame from each of the groups of video frames.

3. The one or more computer storage media of claim 1, the operations further comprising:
generating the image descriptions of the key frames of the source video based on applying a corresponding prompt to a vision language model, the corresponding prompt comprising the key frames from the source video and instructions to generate the image descriptions and estimate a corresponding camera angle for each key frame.

4. The one or more computer storage media of claim 1, wherein the first prompt comprises instructions to estimate a camera motion of the source video based on estimated camera angles of each key frame in the image descriptions.

5. The one or more computer storage media of claim 1, wherein the third prompt comprises instructions to determine corresponding cultural concepts for the target region based on the cultural concepts and predefined cultural guidelines.

6. The one or more computer storage media of claim 1, wherein the third prompt is a single prompt that comprises instructions to generate both (1) the culturalized image description and (2) the culturalized video description.

7. The one or more computer storage media of claim 1, the operations further comprising:
generating the culturalized image from the culturalized image description based on applying a corresponding prompt to a text-to-image model, the corresponding prompt comprising the corresponding image description, a corresponding key frame of the corresponding image description and instructions to generate the culturalized image based on the corresponding image description and structure of the corresponding key frame.

8. The one or more computer storage media of claim 1, wherein the prompt to the generative video model comprises instructions to apply the culturalized image as an initial frame of the culturalized video.

9. A computer-implemented method comprising:
causing a language model to generate a video description of a source video based on applying, via a video description component, a first prompt to the language model, the first prompt comprising image descriptions of key frames from the source video and instructions to generate the video description;
causing the language model to identify cultural concepts from a corresponding image description of the image descriptions based on applying, via a cultural concepts component, a second prompt to the language model, the second prompt comprising the corresponding image description and instructions to identify the cultural concepts;
causing the language model to generate a culturalized image description from the corresponding image description and a culturalized video description of the source video based on applying, via a culturalized description component, a third prompt to the language model, the third prompt comprising the corresponding image description, the video description, the cultural concepts, a target region and instructions to generate the culturalized image description and the culturalized video description;
causing a generative video model to generate a culturalized video based on applying, via a culturalized video component, a prompt to the generative video model, the prompt comprising a culturalized image from the culturalized image description, the culturalized video description, and instructions to generate the culturalized video; and
causing display, via a user interface component, of the culturalized video.

10. The computer-implemented method of claim 9, further comprising:
determining the key frames of the source video by clustering video frames of the source video into groups of video frames based on pixel intensity histograms for each video frame and applying a computer vision technique to select a corresponding key frame from each of the groups of video frames.

11. The computer-implemented method of claim 9, further comprising:
generating the image descriptions of the key frames of the source video based on applying a corresponding prompt to a vision language model, the corresponding prompt comprising the key frames from the source video and instructions to generate the image descriptions and estimate a corresponding camera angle for each key frame.

12. The computer-implemented method of claim 9, wherein the instructions to generate the video description comprise instructions to estimate a camera motion of the source video based on estimated camera angles of each key frame in the image descriptions.

13. The computer-implemented method of claim 9, wherein the instructions to generate the culturalized image description and the culturalized video description comprise instructions to determine corresponding cultural concepts for the target region based on the cultural concepts and predefined cultural guidelines.

14. The computer-implemented method of claim 9, wherein the instructions to generate the culturalized image description and the culturalized video description is provided in a single prompt to the language model.

15. The computer-implemented method of claim 9, the operations further comprising:
generating the culturalized image from the culturalized image description based on applying a corresponding prompt to a text-to-image model the corresponding prompt comprising the corresponding image description, a corresponding key frame of the corresponding image description and instructions to generate the culturalized image based on the corresponding image description and structure of the corresponding key frame.

16. The computer-implemented method of claim 9, wherein the instructions to generate the culturalized video comprise instructions to apply the culturalized image as an initial frame of the culturalized video.

17. A computer system comprising:
one or more processors; and
one or more computer storage media storing computer-useable instructions that, when used by the one or more processors, cause the one or more processors to perform operations, the operations comprising:
determining, via a key frame extraction component, key frames of a source video;
generating, via an image description component, image descriptions of the key frames of the source based on applying, to a vision language model, a first prompt comprising the key frames;
generating, via a video description component, a video description of a source video based on applying, to the language model, a second prompt comprising the image descriptions;
identifying, via a cultural concepts component, cultural concepts from a corresponding image description of the image descriptions based on applying, to the language model, a third prompt comprising the corresponding image description;
generating, via a culturalized description component, a culturalized image description from the corresponding image description and a culturalized video description from the video description based on applying, to the language model, a fourth prompt comprising the corresponding image description, the video description, the cultural concepts, and a target region;
generating, via a culturalized image component, a culturalized image based on applying, to a text-to-image model, a fifth prompt comprising the corresponding image description and a corresponding key frame of the corresponding image description;
generating, via a culturalized video component, a culturalized video based on applying, to a generative video model, a sixth prompt comprising the culturalized image and the culturalized video description; and
causing display, via a user interface component, of the culturalized video.

18. The computer system of claim 17, wherein the operations further comprise:
determining the key frames of the source video by clustering video frames of the source video into groups of video frames based on pixel intensity histograms for each video frame and applying a computer vision technique to select a corresponding key frame from each of the groups of video frames.

19. The computer system of claim 17, wherein the second prompt comprises instructions to estimate a camera motion of the source video based on estimated camera angles of each key frame in the image descriptions.

20. The computer system of claim 17, wherein the fourth prompt comprises instructions to determine corresponding cultural concepts for the target region based on the cultural concepts and predefined cultural guidelines.
